(19) United States
(12) Patent Application Publication
(10) Pub. No.: US 2026/0130338 A1
(43) Pub. Date: May 14, 2026

(54) ANIMAL SEAT BELT APPARATUS

(71) Applicant: DANIEL SHTUTMAN, HOLON (IL)

(72) Inventor: DANIEL SHTUTMAN, HOLON (IL)

(21) Appl. No.: 18/964,733

(22) Filed: Dec. 2, 2024

(30) Foreign Application Priority Data
Nov. 11, 2024 (IL) 316966

(51) Int. Cl. A01K 1/02; A01K 27/00; B60R 22/10

(52) U.S. Cl. CPC A01K 1/0272; A01K 27/002; B60R 22/10

(57) ABSTRACT

An animal seat belt apparatus, including a harness, for confining an animal, a male lock member, extending from the harness, for being inserted into a female lock member of a vehicle, for being locked thereto, and a locking article, extending from the harness, for locking thereto the vehicle belt including a male lock member.

### CROSS-REFERENCE TO RELATED APPLICATIONS

This application claims the benefit of priority from Israel Patent Application No. 316966, filed Nov. 11, 2024, the disclosure of which is incorporated herein by reference.

### TECHNICAL FIELD

The invention relates to the field of animal seat belts.

### BACKGROUND

Prior art dog seat belts do not utilize the existing seat belt of the vehicle, thus are disadvantaged of not utilizing their advantages.

There is a long felt need to provide a solution to the above-mentioned and other problems of the prior art.

### SUMMARY

An animal seat belt apparatus, including:
a harness;
a male lock member; and
a locking article, for locking thereto the vehicle belt.

### BRIEF DESCRIPTION OF THE DRAWINGS

Embodiments, features, and aspects of the invention are described herein in conjunction with the following drawings:

FIG. 1 is a perspective view of an animal seat belt apparatus, according to one embodiment of the invention;

FIG. 2 is a perspective view of the animal seat belt apparatus of FIG. 1 at use;

FIG. 3 is a perspective view of the animal seat belt apparatus of FIG. 1, according to another embodiment;

FIG. 4 is a perspective view of the animal seat belt apparatus of FIG. 3 at use;

FIG. 5 is a perspective view of the insertion of the portion of the seat belt into the lock member of FIG. 4;

FIG. 6 is a front view of the insertion of the portion of the seat belt of FIG. 5;

FIG. 7 is the front view of FIG. 6 at the next step;

FIG. 8 is the front view of the lock member of FIG. 4 according to another embodiment; and

FIG. 9 is the rolled state of FIG. 7 for the lock member of FIG. 8.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

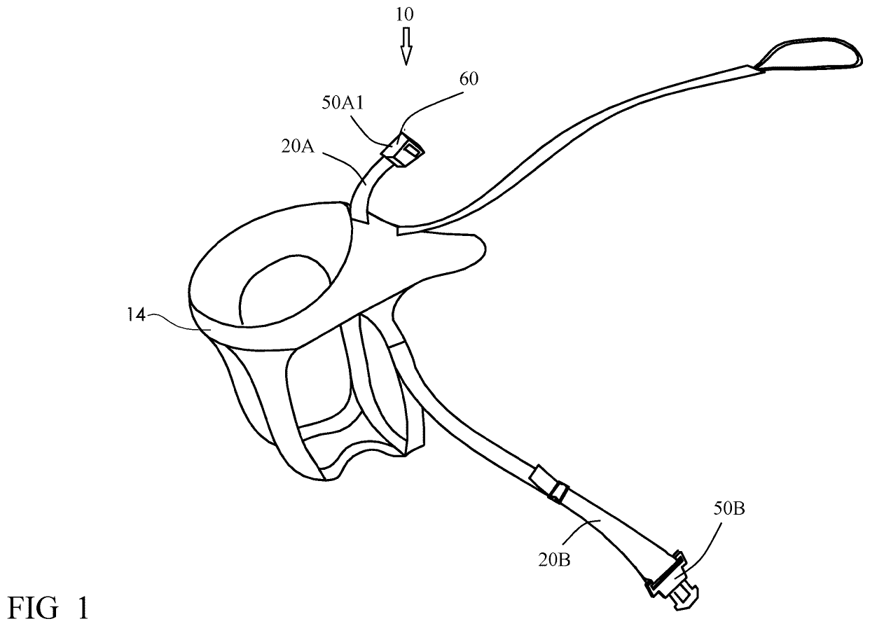

FIG. 1 is a perspective view of an animal seat belt apparatus, according to one embodiment of the invention.

An animal seat belt apparatus 10 includes according to one embodiment a harness 14, from which extends a belt 20A ending with a locking article 50A1 being a belt female member 60; and a belt 20B ending with a male lock member 50B.

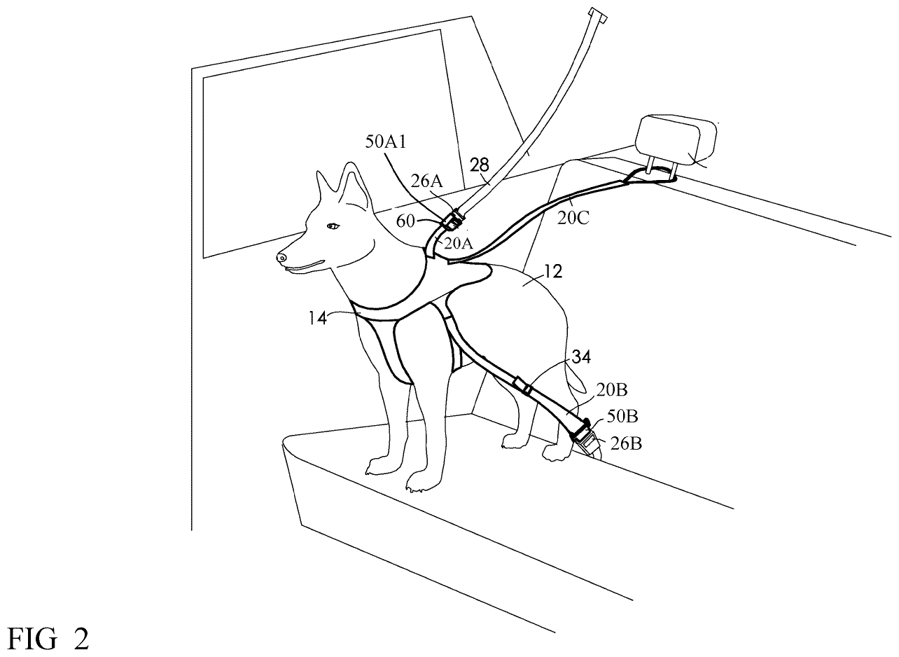

FIG. 2 is a perspective view of the animal seat belt apparatus of FIG. 1 at use.

Harness 14 is for confining animal 12; locking article 50A1 being belt female member 60 is for inserting thereinto male lock member 26A extending from the seat belt 28 of the vehicle; and male lock member 50B is for being inserted into female lock member 26B of the vehicle, rather than inserting male lock member 26A of the vehicle into female lock member 26B of the vehicle.

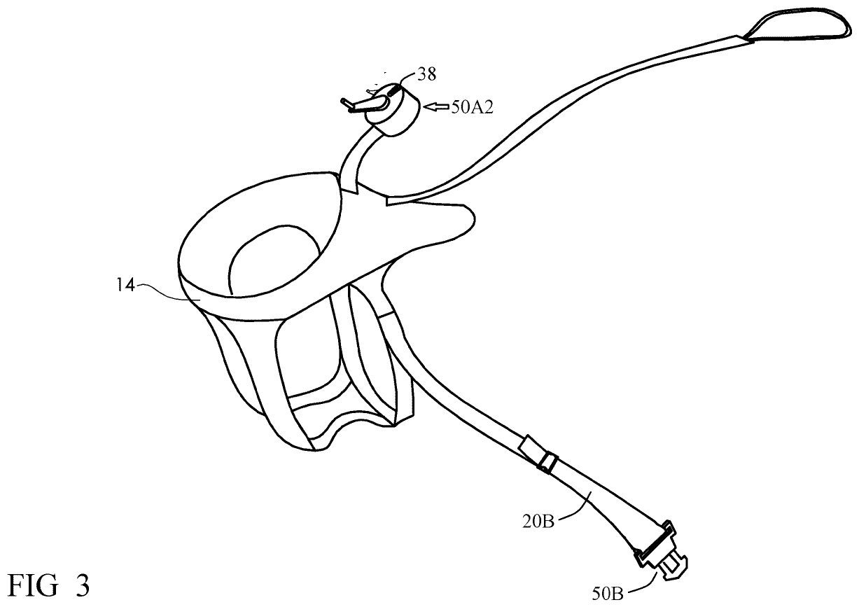

FIG. 3 is a perspective view of the animal seat belt apparatus of FIG. 1, according to another embodiment.

According to another embodiment, animal seat belt apparatus 10 includes harness 14, from which extends belt 20A ending with a locking article 50A2, and belt 20B ending with male lock member 50B.

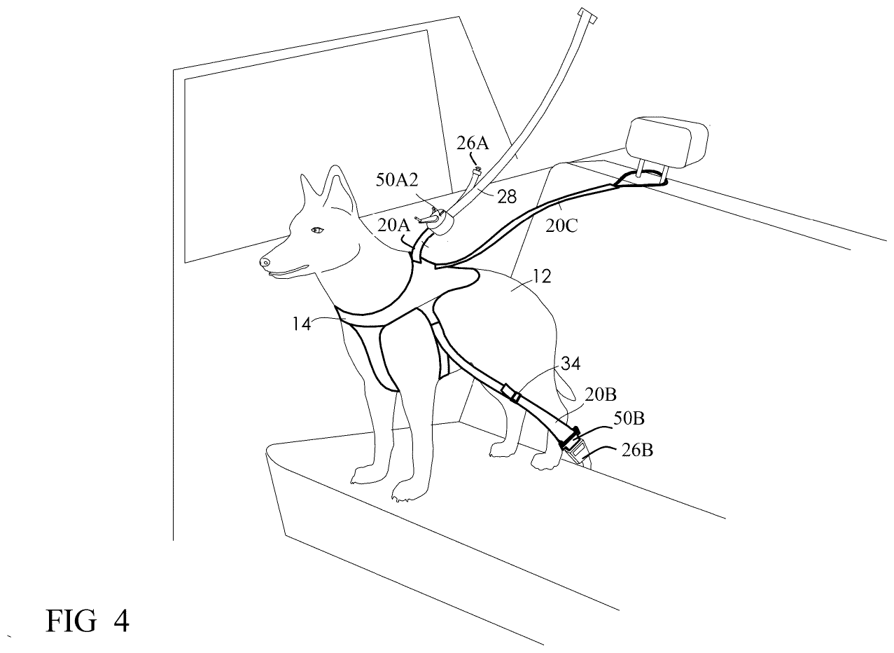

FIG. 4 is a perspective view of the animal seat belt apparatus of FIG. 3 at use.

Harness 14 is for confining animal 12; locking article 50A2 is for inserting thereinto a portion of seat belt 28 of the vehicle; and male lock member 50B is being inserted into female lock member 26B of the vehicle.

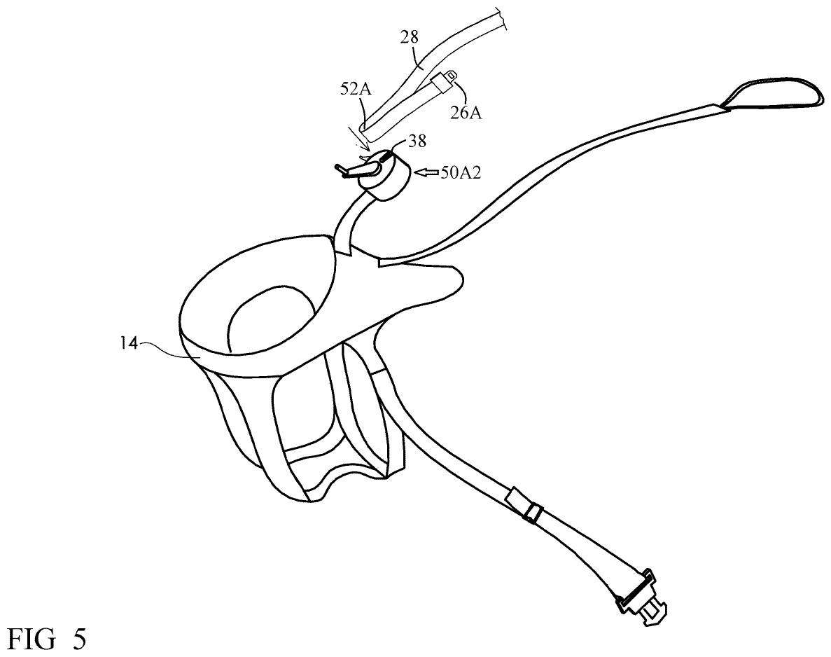

FIG. 5 is a perspective view of the insertion of the portion of the seat belt into the lock member of FIG. 4.

Locking article 50A2 includes a slit 38 into which a portion 52A of vehicle's seat belt 28 is inserted.

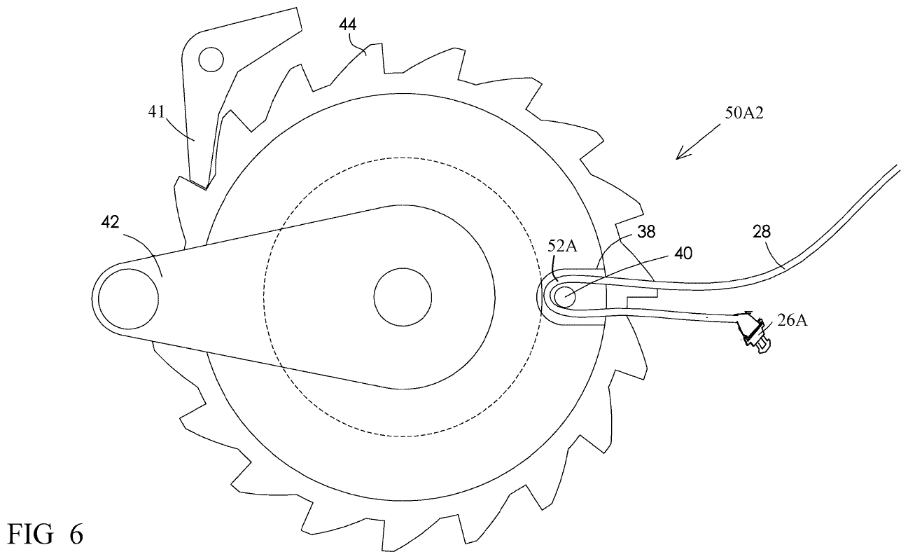

FIG. 6 is a front view of the insertion of the portion of the seat belt of FIG. 5.

Slit 38 includes an anchor 40 for being surrounded by portion 52A of seat belt 28, upon inserting portion 52A into slit 38.

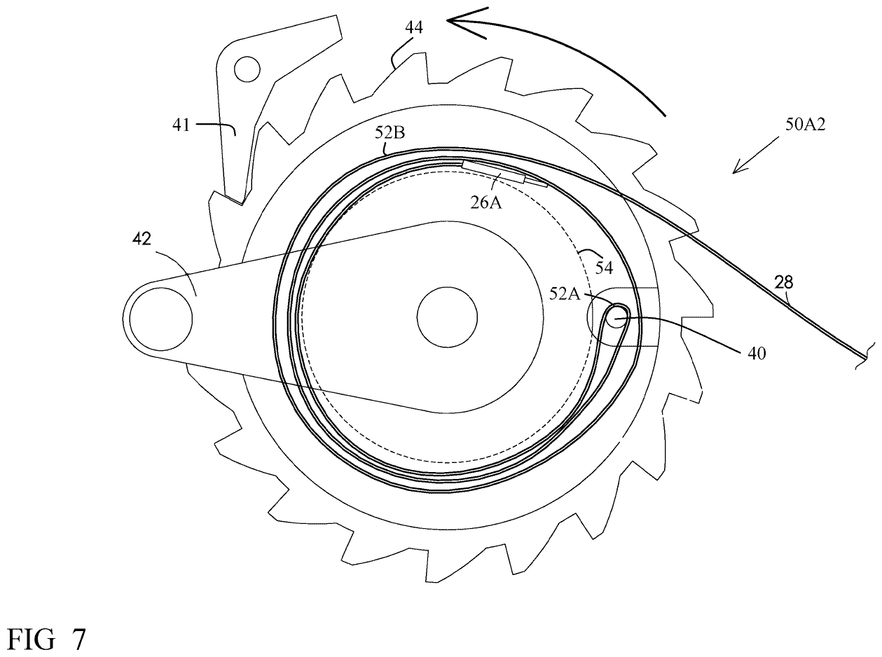

FIG. 7 is the front view of FIG. 6 at the next step.

Locking article 50A2 includes a winch 54 for rolling and releasing vehicle's seat belt 28 including its male lock member 26A, while portion 52A of vehicle's seat belt 28 is anchored by anchor 40.

Winch 54 includes one-directional teeth 44 and a springy teeth lock 40, for normally avoiding release of vehicle's seat belt 28. Rolling of winch 54 by a handle 42 provides adjusting the length from vehicle's seat belt 28 available for the animal.

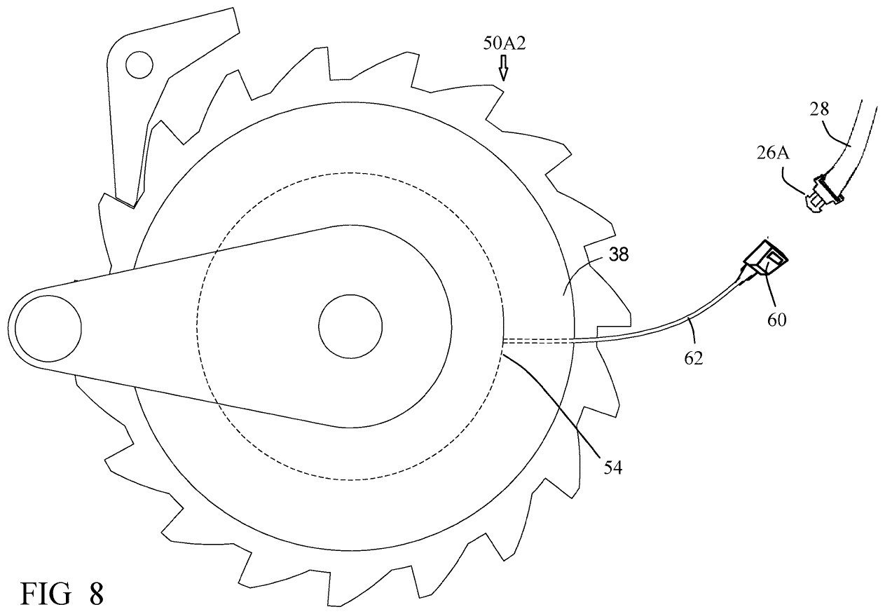

FIG. 8 is the front view of the lock member of FIG. 4 according to another embodiment.

Rather than locking seat belt 28 by locking portion 52A of seat belt 28 by anchor 40 of FIG. 3 to FIG. 7, locking article 50A2 of FIG. 8 includes a short belt 62, whose first end is fixed to winch 54, and whose second end ends with a female locking member 60, for inserting thereinto male member 26A of seat belt 28.

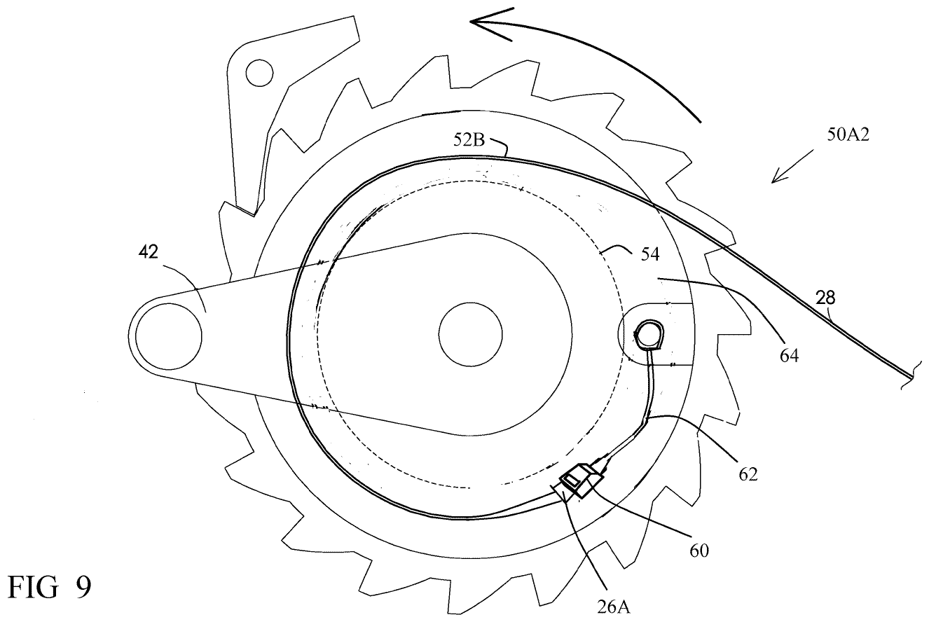

FIG. 9 is the rolled state of FIG. 7 for the lock member of FIG. 8.

Rotating winch 54 rolls belt 62 with its female member 60, and a portion of seat belt 28 with its male member 26A into the drum 64 of winch 54.

Thus, in one aspect, the invention is directed to an animal seat belt apparatus (10), including:
a harness (14), for confining an animal (14);
a male lock member (50B), extending from the harness (14), for being inserted into a female lock member (26B) of a vehicle, for being locked thereto; and
a locking article (50A1,50A2), extending from the harness (14), for locking thereto the vehicle belt (28) including a male lock member (26A).

The locking article (50A1,50A2) may include a female member (60) for inserting thereinto the male lock member (26A) of the vehicle belt (28).

The locking article (50A2) may include an anchor (40) for anchoring thereto a portion (52A) of the vehicle belt (28).

The locking article (50A2) may include a winch (54), for rolling a portion (52B) of the vehicle belt (28), thereby adjusting a length from the vehicle's seat belt (28) available for the animal.

In the figures and description herein, the following reference numbers (Reference Signs List) have been mentioned:
number 10 denotes the animal seat belt apparatus according to one embodiment of the invention;
12: dog or other animal;
14: harness;
20A, 20B, 20C: belts;
26A: vehicle's male lock member;
26B: vehicle's female lock member;
28: vehicle belt;
34: length adjusting member;
38: slit;
40: anchor;
41: springy teeth lock;
42: handle;
50A1,50A2: locking articles;
50B: male lock member;
52A,52B: portions of vehicle belt 28;
54: winch;
60: female locking member;
62: belt;
64: drum of winch 54.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. An animal seat belt apparatus, comprising:
a harness, for confining an animal;
a male lock member, extending from said harness, for being inserted into a female lock member of a vehicle, for being locked thereto; and
a winch extending from said harness, said winch for rolling a first portion of a vehicle belt, which is not of said harness, thereby adjusting a length from said vehicle's seat belt available for the animal.

2. (canceled)

3. The animal seat belt apparatus according to claim 1, wherein said winch comprises an anchor for anchoring thereto a second portion of said vehicle belt.

4. (canceled)

5. (canceled)
